(19) United States
(12) Patent Application Publication
(10) Pub. No.: US 2026/0119248 A1
(43) Pub. Date: Apr. 30, 2026

(54) METHOD AND APPARATUS OF DISTRIBUTED RESOURCE MANAGEMENT, SYSTEM, DEVICE, AND STORAGE MEDIUM

(71) Applicant: SUZHOU METABRAIN INTELLIGENT TECHNOLOGY CO., LTD., Suzhou, Jiangsu (CN)

(72) Inventor: Xianyang GAO, Suzhou, Jiangsu (CN)

(21) Appl. No.: 19/142,143

(22) PCT Filed: May 27, 2024
(86) PCT No.: PCT/CN2024/095399

§ 371 Date: Jun. 20, 2025

(30) Foreign Application Priority Data
Dec. 27, 2023 (CN) 202311824720.5

(51) Int. Cl. G06F 9/50; G06F 11/07

(52) U.S. Cl. CPC G06F 9/5027; G06F 11/079; G06F 2209/503

(57) ABSTRACT

Embodiments of the present application provide a method of distributed resource management, apparatus, and system, a device, and a non-transitory readable storage medium, which relate to the field of computer technologies. The method includes: in response to receiving a power-on instruction, controlling a switch, a target device, and a target computing unit to power on synchronously; in response to receiving a reset instruction, performing a reset operation on a to-be-reset device indicated by the reset instruction, wherein the to-be-reset device includes at least one of the target devices, the target computing units, and the switch; and performing resource scheduling on target resources in the plurality of resource pools based on a resource scheduling request, wherein the resource scheduling includes resource reset and resource allocation. In this way, the distributed resource management system may achieve resetting of the entire system or device, supports both resource reset and resource reallocation during the resource scheduling process, provides a more efficient and flexible resource management architecture, achieves lifecycle management of pooled resources, and improves the practicability and flexibility of resource management.

### CROSS-REFERENCE TO RELATED APPLICATION

This disclosure claims the priority of the Chinese Patent application filed on Dec. 27, 2023 before the CNIPA, China National Intellectual Property Administration with the application number of 202311824720.5, and the title of “METHOD AND APPARATUS OF DISTRIBUTED RESOURCE MANAGEMENT, SYSTEM, DEVICE, AND STORAGE MEDIUM”, which is incorporated herein in its entirety by reference.

### FIELD

The present disclosure relates to the field of computer technologies, and particularly relates to a method and apparatus of distributed resource management, and a system, a device, and a non-transitory readable storage medium.

### BACKGROUND

Scenarios such as artificial intelligence and machine learning, high-performance computing, and cloud and edge computing environments are complex and diverse. In order to meet resource demands, optimization and reconstruction of a server hardware architecture are required to improve resource utilization and reduce maintenance costs. In related technologies, various types of resources in server architectures are in an isolated state. Correspondingly, resource scheduling methods for various types of resources are linear, that is, different types of resources cannot work collaboratively, which negatively impacts the overall operational efficiency of a server.

### SUMMARY

The present disclosure provides a method and apparatus of distributed resource management, and a system, a device, and a non-transitory readable storage medium.

In a first aspect, the present disclosure provides a method of distributed resource management, applied to a distributed resource management system deployed in a server, wherein the distributed resource management system includes a switch and a plurality of resource pools, the plurality of resource pools are formed by respectively connecting the switch to first resources corresponding to a target device in the server or to second resources corresponding to a target computing unit in the server via compute express link; and the method includes:
in response to receiving a power-on instruction, controlling the switch, the target device, and the target computing unit to power on synchronously;
in response to receiving a reset instruction, performing a reset operation on a to-be-reset device indicated by the reset instruction, wherein the to-be-reset device includes at least one of the target device, the target computing unit, and the switch; and
performing resource scheduling on target resources in the plurality of resource pools based on a resource scheduling request, wherein the resource scheduling includes resource reset and resource allocation.

In some embodiments, the method further includes:
in response to collecting target fault information corresponding to any one of the resource pools, determining a fault location, a fault type, and a fault recovery strategy based on the target fault information.

In some embodiments, the switch includes a core switch and a plurality of access switches, the core switch is connected to the plurality of access switches, and each access switch is configured to connect to a plurality of target devices of the same type or to a plurality of target computing units of the same type via the compute express link.

In some embodiments, the method further includes:
acquiring resource usage information corresponding to the target device and the target computing unit; and
performing resource analysis on the target device and the target computing unit based on the resource usage information, to obtain resource monitoring data.

In some embodiments, the switch is deployed in a switch chassis, the target device is deployed in a device chassis, and the target computing unit is deployed in a host chassis; and the in response to receiving a power-on instruction, controlling the switch, the target device, and the target computing unit to power on synchronously includes:
in response to a baseboard management controller in the switch chassis receiving a power-on signal and a power good signal from the device chassis and the host chassis, controlling a complex programmable logic device in the switch chassis to supply power to the switch based on a first enable signal, wherein the power-on signal is generated based on the power-on instruction; and
controlling the baseboard management controller in the switch chassis to transmit the power-on signal to a baseboard management controller in the device chassis and a baseboard management controller in the host chassis, to supply power to the target device and the target computing unit.

In some embodiments, a power-on signal transmitted to a complex programmable logic device in the device chassis is configured for enabling the complex programmable logic device in the device chassis to supply power to the target device based on a second enable signal; and

a power-on signal transmitted to a complex programmable logic device in the host chassis is configured for enabling the complex programmable logic device in the host chassis to supply power to the target computing unit based on a third enable signal.

In some embodiments, the power good signal includes a first power good signal, and the method further includes:
controlling a power supply unit of the device chassis to supply power to components in the device chassis based on a standby voltage;
in response to the components in the device chassis receiving the standby voltage, generating a power good signal and transmitting the power good signal to a complex programmable logic device and the baseboard management controller in the device chassis; and
controlling the baseboard management controller in the device chassis to transmit the first power good signal to the baseboard management controller in the switch chassis.

In some embodiments, the power good signal includes a second power good signal, and the method further includes:
controlling a power supply unit of the host chassis to supply power to components in the host chassis based on a standby voltage;
in response to the components in the host chassis receiving the standby voltage, generating a power good signal and transmitting the power good signal to the complex programmable logic device and the baseboard management controller in the host chassis; and
controlling the baseboard management controller in the host chassis to transmit the second power good signal to the baseboard management controller in the switch chassis.

In some embodiments, the method further includes:
controlling the baseboard management controller in the host chassis to scan a first interface corresponding to both the host chassis and the switch chassis, to obtain a first topology diagram corresponding to the host chassis and the switch chassis; and
controlling the baseboard management controller in the switch chassis to scan a second interface corresponding to both the device chassis and the switch chassis, to obtain a second topology diagram corresponding to the switch chassis and the device chassis.

In some embodiments, the resource scheduling request includes a resource release request, and the performing resource scheduling on target resources in the plurality of resource pools based on a resource scheduling request includes:
in response to receiving the resource release request, removing a to-be-reconfigured device corresponding to a to-be-reallocated resource indicated by the resource release request from the second topology diagram and determining device information corresponding to the to-be-reconfigured device, wherein the target resources in the plurality of resource pools include the to-be-reallocated resource; and
resetting the to-be-reconfigured device based on the device information.

In some embodiments, the resetting the to-be-reconfigured device includes:
transmitting a first reset signal to the complex programmable logic device in the switch chassis based on the baseboard management controller in the switch chassis; and
transmitting the first reset signal to a complex programmable logic device in the device chassis corresponding to the to-be-reconfigured device by the complex programmable logic device in the switch chassis via a target interface, wherein the complex programmable logic device in the device chassis is configured to forward the first reset signal to the to-be-reconfigured device to perform a reset operation.

In some embodiments, the resource scheduling request further includes a resource acquisition request, and the method further includes:
allocating the to-be-reallocated resource to a designated computing unit indicated by the resource acquisition request based on the resource acquisition request.

In some embodiments, the reset instruction includes a system reset instruction, and the to-be-reset device includes the switch, the target computing unit, and the target device; and the in response to receiving a reset instruction, performing a reset operation on a to-be-reset device indicated by the reset instruction includes:
generating a system reset signal by the target computing unit based on the system reset instruction, and performing a reset operation on the target computing unit by the target computing unit based on the system reset signal; and
controlling the target computing unit to transmit the system reset signal to a complex programmable logic device in a switch chassis and a complex programmable logic device in a device chassis, to perform reset operations on the switch and the target device.

In some embodiments, the controlling the target computing unit to transmit the system reset signal to a complex programmable logic device in a switch chassis and a complex programmable logic device in a device chassis includes:
controlling the target computing unit to transmit the system reset signal to a baseboard management controller in the switch chassis via a baseboard management controller in a host chassis;
controlling the baseboard management controller in the switch chassis to transmit the system reset signal to the complex programmable logic device in the switch chassis and to the switch, to perform a reset operation on the switch; and
controlling the baseboard management controller in the switch chassis to transmit the system reset signal to the complex programmable logic device in the device chassis via a target interface, wherein the system reset signal is configured for enabling the complex programmable logic device in the device chassis to perform a reset operation based on the system reset signal.

In some embodiments, the reset instruction includes a device reset instruction, and the to-be-reset device includes a target reset device; and the in response to receiving a reset instruction, performing a reset operation on a to-be-reset device indicated by the reset instruction includes:
generating a device reset signal by a baseboard management controller in a switch chassis based on the device reset instruction, and transmitting the device reset signal to a complex programmable logic device in the switch chassis; and
controlling the complex programmable logic device in the switch chassis to transmit the device reset signal to a complex programmable logic device in a target device chassis corresponding to the device reset instruction via a target interface, to perform a reset operation on the target reset device indicated by the device reset instruction.

In some embodiments, the distributed resource management system further includes a master management controller; and the method further includes:
acquiring device asset information and interface connection state information corresponding to the target device in the distributed resource management system by the master management controller.

In a second aspect, the present disclosure provides a distributed resource management apparatus, applied to a distributed resource management system deployed in a server, wherein the distributed resource management system includes a switch and a plurality of resource pools, the plurality of resource pools are formed by respectively connecting the switch to first resources corresponding to a target device in the server or to second resources corresponding to a target computing unit in the server via compute express link; and the apparatus includes:
a first control module, configured to control the switch, the target device, and the target computing unit to power on synchronously in response to receiving a power-on instruction;
a first reset module, configured to perform a reset operation on a to-be-reset device indicated by a reset instruction in response to receiving the reset instruction, wherein the to-be-reset device includes at least one of the target device, the target computing unit, and the switch; and
a first scheduling module, configured to perform resource scheduling on target resources in the plurality of resource pools based on a resource scheduling request, wherein the resource scheduling includes resource reset and resource allocation.

In a third aspect, the present disclosure provides a distributed resource management system, wherein the distributed resource management system is configured to implement the distributed resource management method according to any one of the first aspects.

In a fourth aspect, the present disclosure provides an electronic device, including:
a processor, a memory, and a computer program stored on the memory and runnable on the processor, wherein the processor, when executing the program, implements the distributed resource management method according to any one of the first aspects.

In a fifth aspect, the present disclosure provides a non-transitory readable storage medium, wherein when instructions stored in the non-transitory readable storage medium are executed by a processor of an electronic device, the electronic device is caused to implement one or more of the distributed resource management methods according to the first aspects.

In some embodiments of the present disclosure, the switch in the distributed resource management system connects the first resources corresponding to the target devices and the second resources corresponding to the target computing units via compute express link (CXL), thereby forming the resource pools and achieving hardware decoupling of the first resources and second resources within the server. Through the switch, efficient coordination of the first resources and the second resources within the distributed resource management system may be achieved, and operational efficiency of the distributed resource management system is improved. Meanwhile, in response to the power-on instruction being received, centralized power-on control of the units within the distributed resource management system may be performed, thereby enhancing operational consistency of the system; in response to the reset instruction being received, the reset operation may be performed on the to-be-reset device indicated by the reset instruction; and resource scheduling (including resource reset and resource allocation) may be performed on the target resources in the plurality of resource pools based on the resource scheduling request. In this way, the distributed resource management system in some embodiments of the present disclosure may implement system-wide or device-specific reset, supports both resource reset and resource reallocation during the resource scheduling process, provides a more efficient and flexible resource management architecture, achieves lifecycle management of pooled resources, and improves the practicability and flexibility of resource management to a certain extent. Moreover, a holistic resource management scheme of the distributed resource management system further enhances overall operational efficiency.

### BRIEF DESCRIPTION OF THE DRAWINGS

In order to describe technical solutions of the embodiments of the present disclosure more clearly, the accompanying drawings used in the illustration of the embodiments will be briefly introduced. Apparently, the accompanying drawings in the following explanation illustrate merely some embodiments of the present disclosure, and those skilled in the art may obtain other accompanying drawings based on these accompanying drawings without paying any creative effort.

FIG. 1 is a flowchart of steps of a method of distributed resource management according to an embodiment of the present disclosure;

FIG. 2 is a schematic diagram of a server deployed with a distributed resource management system according to an embodiment of the present disclosure;

FIG. 3 is a schematic diagram of a connection architecture between a switch and a resource pool according to an embodiment of the present disclosure;

FIG. 4 is a schematic diagram of a distributed resource-pooled integrated solution according to an embodiment of the present disclosure;

FIG. 5 is a block diagram of entire distributed resource-pooled management software according to an embodiment of the present disclosure;

FIG. 6 is a topology diagram of coordinated power-on and power-off functionality of a distributed resource management system according to an embodiment of the present disclosure;

FIG. 7 is a flowchart of steps of scheduling resources according to an embodiment of the present disclosure;

FIG. 8 is a topology diagram of reset functionality of a distributed resource management system according to an embodiment of the present disclosure;

FIG. 9 is a structural diagram of an apparatus of distributed resource management according to an embodiment of the present disclosure; and

FIG. 10 is a structural diagram of an electronic device according to an embodiment of the present disclosure.

### DETAILED DESCRIPTION

A clear and thorough description for technical solutions in the embodiments of the present disclosure will be given below in conjunction with the accompanying drawings in the embodiments of the present disclosure. Apparently, the described embodiments are a part of embodiments of the present disclosure, not all the embodiments. All other embodiments obtained, based on the embodiments in the present disclosure, by those skilled in the art without paying creative effort fall within the protection scope of the present disclosure.

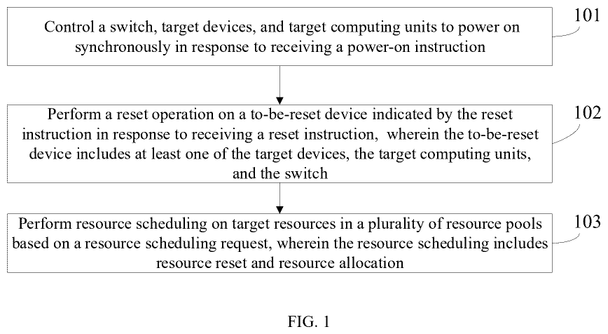

FIG. 1 is a flowchart of steps of a method of distributed resource management provided by some embodiments of the present disclosure. The method of distributed resource management is applied to a distributed resource management system deployed in a server. The distributed resource management system includes a switch and a plurality of resource pools. The plurality of resource pools are constructed by respectively connecting the switch to first resources corresponding to target devices in the server or second resources corresponding to target computing units in the server via compute express link (CXL).

In some embodiments of the present disclosure, the server may be a distributed resource-pooled server, and a distributed resource management system is deployed in the server. The distributed resource management system may be a switch-centric resource management system, and specifically may be configured to decouple and pool different resources within the server based on the switch, and to achieve coordinated resource scheduling on this basis. The distributed resource management system includes a master management controller, a management engine, the switch, and the plurality of resource pools. The master management controller may be configured to perform management on the resource pools and the switch, such as asset management, and power-on and power-off management. The master management controller may be a Pooled System Management Controller (PSMC), and the management engine may be a pooling management engine. The switch may be a CXL switch, i.e., a switch based on CXL. The target devices in the server may include an memory (DDR, Double Data Rate SDRAM), a hard disk which may include a Solid State Disk (SSD) that uses Non Volatile Memory Host Controller Interface Specification(NVME) and adopts form factors such as E3.S (Enterprise and Data Center Standard Form Factor E3.S), as well as accelerators such as a Field Programmable Gate Array (FPGA) and a Graphics Processing Unit (GPU). The target computing unit may be a processor (CPU, Central Processing Unit). Accordingly, the first resources may include processor resources, and the second resources may include memory resources, storage resources, and accelerator resources. The plurality of resource pools may include a processor resource pool, an memory resource pool, a storage resource pool, and an accelerator resource pool.

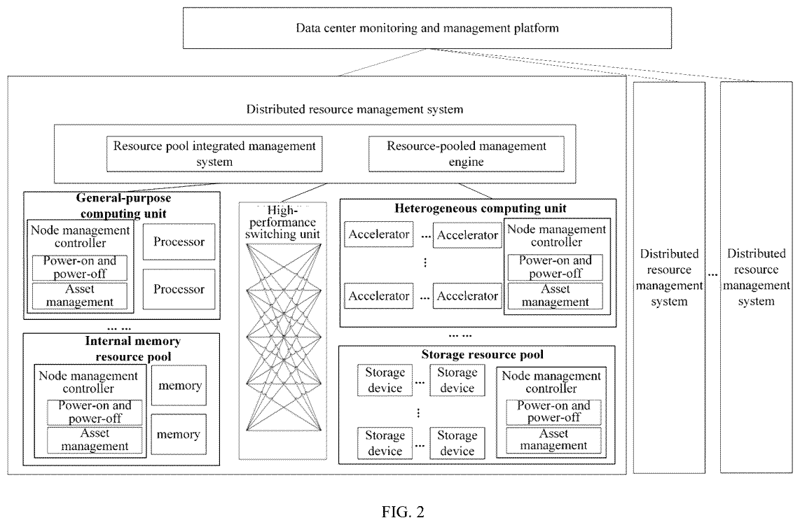

In a possible implementation, FIG. 2 is a schematic diagram of a server deployed with a distributed resource management system. As shown in FIG. 2, a plurality of distributed resource management systems may be configured within a single server as required, and the plurality of distributed resource management systems may be uniformly managed by a data center monitoring and management platform. A number of resource pools in different distributed resource management systems may be defined and allocated as required. Exemplarily, each distributed resource management system may include a master management controller (e.g., a resource pool integrated management system shown in FIG. 2), a management engine (e.g., a resource-pooled management engine shown in FIG. 2), a switch (e.g., a high-performance switching unit shown in FIG. 2), and a plurality of resource pools (including a general-purpose computing unit resource pool, a heterogeneous computing unit resource pool, an memory resource pool, and a storage resource pool). The resource pool integrated management system and the resource-pooled management engine may be configured to perform management, monitoring, and deployment control on the switch (e.g., the high-performance switching unit in FIG. 2), the general-purpose computing unit (including CPUs), heterogeneous computing units (including GPUs, FPGAs, Application Specific Integrated Circuits (ASICs), and Data Processing Units (DPUs)), an memory (including DRAM, Dynamic Random Access Memory), storage devices (including SSDs), and each resource pool based on Ethernet (Eth). The resource pool integrated management system may include functions such as a remote monitoring and management interface (Application Programming Interface, API) function, a system-wide reset management function, a system-wide power-on/power-off management function, and a centralized asset management function. The resource-pooled management engine may include functions such as topology recognition, topology display, and dynamic resource allocation.

In some embodiments of the present disclosure, the switch is connected to the target devices and the target computing units via CXL. To sufficiently meet usage requirements, the switch may include a core switch and access switches. Specifically, the core switch may be connected to the plurality of access switches. Exemplarily, the core switch and the plurality of access switches may be connected in a star topology, and the core switch and the access switches may form a high-performance switching unit. The core switch and the access switches may each include one or more switching chips, and each access switch is connected to a respective resource pool. Any given access switch may be connected to the target devices of the same type and the target computing units of the same type. In other words, one access switch may be connected to a plurality of memories to construct an memory resource pool; one access switch may be connected to a plurality of storage devices to construct a storage resource pool; one access switch may be connected to a plurality of accelerators to construct an accelerator resource pool; and one access switch may be connected to a plurality of processors to construct a processor resource pool. By connecting the plurality of access switches to the core switch, memory resources, processor resources, heterogeneous accelerator resources, storage resources, and other resources are decoupled and pooled in a distributed manner via the CXL. The switch is then configured to perform compute power scheduling and resource allocation within the server.

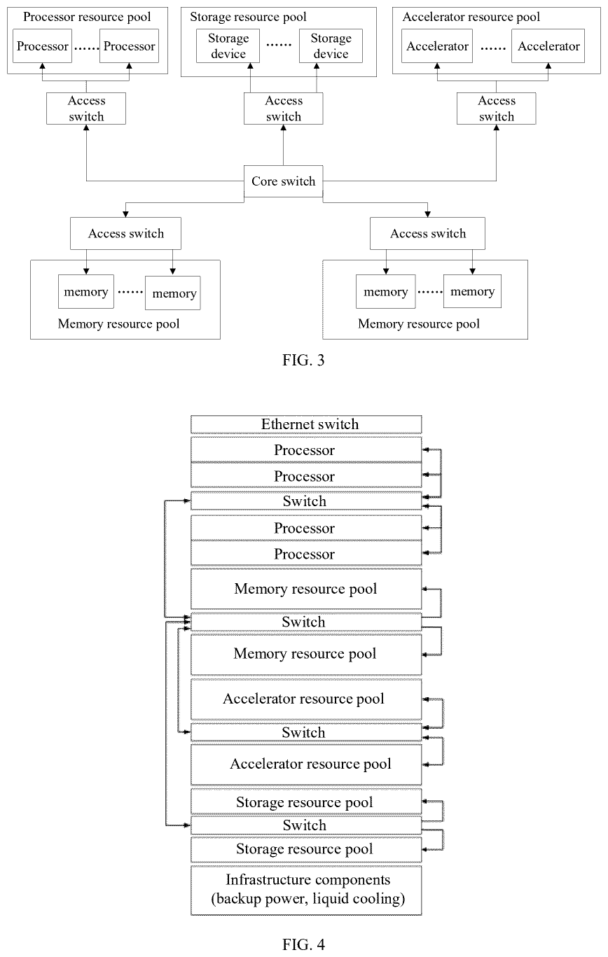

Exemplarily, FIG. 3 is a schematic diagram of a connection architecture between a switch and a resource pool. As shown in FIG. 3, a core switch is connected to 5 access switches. The 5 access switches are respectively connected to a processor resource pool, a storage resource pool, an accelerator resource pool, and an memory resource pool. It can be understood that for target devices or computing units of the same type, a plurality of resource pools may be configured based on specific requirements and connected to the access switches. For example, as shown in FIG. 3, two access switches are connected to two memory resource pools.

Exemplarily, FIG. 4 is a schematic diagram of a distributed resource-pooled integrated solution. FIG. 4 illustrates an integrated system architecture corresponding to a distributed resource management system, which includes an Ethernet switch, processors, switches (e.g., CXL switches), an memory resource pool, an accelerator resource pool, a storage resource pool, and infrastructure components. In FIG. 4, devices connected by bidirectional arrows can function as either a master device or a slave device in the wiring process, whereas a device pointed to by a unidirectional arrow only functions as a slave device in the wiring process. For example, a bidirectional arrow 1 connects a switch and an accelerator resource pool, which indicates that the accelerator resource pool may function as a master device to access resource data from other devices via the switch. Meanwhile, a unidirectional arrow 1 points to a switch and an memory resource pool, which indicates that external devices may access data from the memory resource pool via the switch.

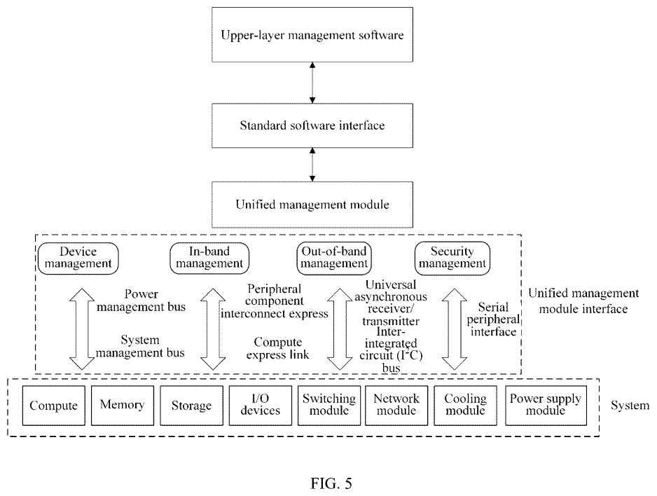

Exemplarily, a distributed resource-pooled system may be implemented through distributed resource-pooled management software. FIG. 5 is a block diagram of entire distributed resource-pooled management software. As shown in FIG. 5, upper-layer management software may include a bootloader, an operating system kernel, and a management software layer. The bootloader and the operating system kernel include management units and various hardware drivers, such as drivers for an Inter-Integrated Circuit (I²C), Universal Asynchronous Receiver/Transmitter (UART), and Serial Peripheral Interface (SPI), and provide a unified upper-layer interface and management services for different architectural platforms such as x86 and advanced RISC machine (ARM). The management software layer may include common applications such as firmware management, power and thermal control, log management, fault diagnostics, and remote control. The upper-layer management software communicates with the Unified Management Module (UMM) via standard software interfaces, such as Restful APIs, to implement various functions of the distributed resource-pooled system. Furthermore, users may manage the distributed resource-pooled system directly through a web interface (such as buttons and selection boxes). The UMM provides standard Restful API interfaces to the upper-layer management software and communicates downward with system hardware (such as an memory, storage devices, input/output (I/O) devices, switching modules, network modules, cooling modules, and power supply modules) via the UMMI (Unified Management Module Interface). This enables the upper-layer management software to implement control and management of the system hardware via the UMM. The UMMI may include a power management bus (PMBus), a system management bus (SMBus), peripheral component interconnect express (PCIe), compute express link (CXL), a UART interface, an I²C bus, and an SPI. Specifically, device management is implemented via PMBus and SMBus; in-band management is implemented via PCIe and CXL; out-of-band management is implemented via the UART interface and the I²C bus; and security management is implemented through SPI.

As shown in FIG. 1, a method of distributed resource management may include the following steps.

Step 101, in response to receiving a power-on instruction, controlling a switch, target devices, and target computing units to power on synchronously.

In some embodiments of the present disclosure, in response to receiving the power-on instruction, a distributed resource management system controls the switch, the target devices, and the target computing units to power on synchronously based on the power-on instruction. Correspondingly, the distributed resource management system may also control the switch, the target devices, and the target computing units to power off synchronously. The power-on instruction may be triggered based on a preset action, such as pressing a power button of a switch chassis corresponding to the switch. Based on the power-on instruction, a power-on signal is generated and transmitted to a baseboard management controller and a complex programmable logic device in the switch chassis. The complex programmable logic device controls a power-on process of the switch. Furthermore, through the transmission of the power-on signal between the baseboard management controller in the switch chassis, a baseboard management controller in a host chassis and a baseboard management controller in a device chassis, the target computing units in the host chassis and the target devices in the device chassis are controlled to power on. Communication between the baseboard management controller in the switch chassis, the baseboard management controller in the host chassis, and the baseboard management controller in the device chassis may be implemented via an Ethernet network.

Step 102, in response to receiving a reset instruction, performing a reset operation on a to-be-reset device indicated by the reset instruction, wherein the to-be-reset device includes at least one of the target devices, the target computing units, and the switch.

In some embodiments of the present disclosure, in response to receiving the reset instruction, the distributed resource management system performs a reset operation on the to-be-reset device indicated by the reset instruction. The reset instruction may carry an indication of the to-be-reset device, and the to-be-reset device is reset based on the reset instruction. The reset instruction may be issued by a processor, and the to-be-reset device may include at least one of the target devices, the target computing units, and the switch. In other words, the distributed resource management system may reset a single target device, target computing unit, and switch, or reset a plurality of target devices, target computing units, and/or switches. It is understood that the to-be-reset device may include the target devices, the target computing units, and the switch, i.e., the distributed resource management system supports a system-wide reset function.

In practical application scenarios, the reset instruction may be triggered in response to system errors, unrecognized devices, or similar events, and the system and/or hardware (devices) may be rebooted based on the reset instruction.

Step 103, performing resource scheduling on target resources in a plurality of resource pools based on a resource scheduling request, wherein the resource scheduling includes resource reset and resource allocation.

In some embodiments of the present disclosure, based on the resource scheduling request, resource scheduling may be performed on the target resources indicated in the resource scheduling request according to content specified therein. The resource scheduling request may include a resource reallocation request, a resource release request, or a resource acquisition request. Exemplarily, the resource reallocation request may be configured for instructing the release of a target resource corresponding to a first task and allocation of the target resource to a second task. The resource release request may be configured for instructing the release of the target resource corresponding to the first task, and the resource acquisition request may be configured for instructing the allocation of the target resource to the second task. The target resource may be any one or more resources from the plurality of resource pools, such as an memory resource, an accelerator resource, a processor resource, and the like. Resource scheduling may include resource reset (i.e., resource releasing) and resource matching. The resource reset may be implemented by performing a reset operation on the target device or the target computing unit corresponding to the resource. For example, when the target resource is an memory resource, the memory resource may be reset by performing a reset operation on an memory device. Resource matching refers to matching resources to corresponding tasks as needed.

In conclusion, in some embodiments of the present disclosure, the switch in the distributed resource management system connects the first resources corresponding to the target devices and the second resources corresponding to the target computing units via compute express link (CXL), thereby forming the resource pools and achieving hardware decoupling of the first resources and second resources within the server. Through the switch, efficient coordination of the first resources and the second resources within the distributed resource management system may be achieved, and operational efficiency of the distributed resource management system is improved. Meanwhile, in response to the power-on instruction being received, centralized power-on control of the units within the distributed resource management system may be performed, thereby enhancing operational consistency of the distributed resource management system; in response to the reset instruction being received, the reset operation may be performed on the to-be-reset device indicated by the reset instruction; and resource scheduling (including resource reset and resource allocation) may be performed on the target resources in the plurality of resource pools based on the resource scheduling request. In this way, the distributed resource management system in some embodiments of the present disclosure may implement system-wide or device-specific reset, supports both resource reset and resource reallocation during the resource scheduling process, provides a more efficient and flexible resource management architecture, achieves lifecycle management of pooled resources, and improves the practicability and flexibility of resource management to a certain extent. Moreover, a holistic resource management scheme of the distributed resource management system further enhances overall operational efficiency.

Optionally, some embodiments of the present disclosure further include the following steps.

Step 201, in response to collecting target fault information corresponding to any one of resource pools, determining a fault location, a fault type, and a fault recovery strategy based on the target fault information.

In some embodiments of the present disclosure, the distributed resource management system further includes a master management controller and node management controllers. Each node management controller is configured to perform power-on/off management and asset management on the resources and devices corresponding to each resource pool. The master management controller serves as a central management node, while the node management controllers serve as distributed nodes managed uniformly by the master management controller. The master management controller is configured to perform remote monitoring and management, system-wide reset management, system-wide power-on/off management, and centralized asset management.

When the node management controller corresponding to any resource pool monitors, checks, and analyzes a health status and fault information of the resource pool, and if a server within the node management controller collects target fault information corresponding to the resource pool, the target fault information may be transmitted to a client within the master management controller via a network based on an Intelligent Platform Management Interface (IPMI) or the Redfish protocol. The client in the master management controller then determines the fault location, fault type, and fault recovery strategy based on the received target fault information. The server may include a protocol layer, a parsing layer, and a driver layer. The protocol layer includes an IPMI and a Redfish protocol (the Redfish Scalable Platforms Management API, a specification for scalable platform management). The parsing layer is configured to extract parameters, while the driver layer may include a Joint Test Action Group (JTAG) interface and General Purpose Input/Output (GPIO) interfaces. The client is configured to simulate various types of resource faults within different topologies and may include an application layer, a function layer, and a protocol layer. The function layer includes fault injection scripts, and the protocol layer includes the IPMI and Redfish protocols. The fault location may include fans, central processing units (CPUs), an memory, graphics processing units (GPUs), storage devices, network devices, and Peripheral Component Interconnect Express (PCIe) extension devices. The fault types may include two major categories: crash-type faults and non-crash-type faults. The crash-type faults mainly include system crashes during boot process or at runtime, whereas the non-crash-type faults may include abnormal power supply temperature indicators, fan malfunctions, device malfunctions, and other non-critical faults. The fault recovery strategy may be a remedial strategy determined based on target fault information to repair the fault.

In response to receiving the target fault information, the client in the master management controller may analyze the target fault information by using a fault analysis model to determine the fault location, fault type, and fault recovery strategy. The fault analysis model may be obtained by continuously training a large volume of annotated fault data until the model parameters converge, and performing fine-tuning and adjustment on the parameters. Specifically, the target fault information, after being compressed and serialized into protocol format, may be input into the fault analysis model, and then the fault analysis model outputs the fault location, fault type, and fault recovery strategy.

In some embodiments of the present disclosure, the distributed resource management system may be provided with a system fault management mechanism. By collecting target fault information corresponding to each resource pool and intelligently identifying the fault location and fault type based on the target fault information, and determining the fault recovery strategy, faults within the distributed resource management system may be promptly monitored and identified. In this way, rapid response may be made and the stability and reliability of the system are enhanced.

Optionally, some embodiments of the present disclosure further include the following steps.

Step 301, acquiring resource usage information corresponding to target devices and target computing units.

In some embodiments of the present disclosure, the resource usage information corresponding to the target devices or the target computing units may be obtained via node management controllers corresponding to each resource pool. Specifically, the node management controllers may monitor a resource usage status of the target devices or target computing units in real time to obtain the resource usage information. The resource usage information may include processor utilization, memory utilization, and network bandwidth utilization.

Step 302, performing resource analysis on the target devices and the target computing units based on the resource usage information, to obtain resource monitoring data.

In some embodiments of the present disclosure, resource analysis may be performed on the target devices and the target computing units based on the resource usage status indicated by the resource usage information, to obtain the resource monitoring data. The resource monitoring data may include resource utilization, task execution time, a task completion status, and the like. By acquiring the resource monitoring data, subsequent resource planning and decision making may be performed based on the resource monitoring data, such as increasing or reducing computing units and adjusting resource allocation strategies, to ensure system performance and efficiency.

Optionally, the switch may be deployed in a switch chassis, the target device may be deployed in a device chassis, and the target computing unit may be deployed in a host chassis.

In some embodiments of the present disclosure, the switch may be deployed in the switch chassis (SW chassis), the target device may be deployed in the device chassis, and the target computing unit may be deployed in the host chassis. The switch chassis may include a switch, a baseboard management controller (BMC), a complex programmable logic device (CPLD), a power supply unit, an on-board DC-DC voltage regulator (VR), and other components such as network interface cards (NICs). The device chassis may include the target devices, a baseboard management controller, a complex programmable logic device (CPLD), a power supply unit, an on-board DC-DC voltage regulator, and other components such as NICs. The host chassis may include the target computing units, a baseboard management controller, a complex programmable logic device (CPLD), a power supply unit, an on-board DC-DC voltage regulator, and other components such as NICs.

Step 401, in response to a baseboard management controller in a switch chassis receiving a power-on signal and power good signals from a device chassis and a host chassis, controlling a complex programmable logic device in the switch chassis to supply power to a switch based on a first enable signal, wherein the power-on signal is generated based on a power-on instruction.

In some embodiments of the present disclosure, in response to receiving the power-on instruction, the power-on signal is generated and transmitted to the complex programmable logic device and the baseboard management controller in the switch chassis. In response to the baseboard management controller in the switch chassis receiving the power-on signal and power good signals respectively transmitted from the device chassis and the host chassis, it indicates that synchronous power-on may be performed on the switch, the target devices, and the target computing units based on the power-on signal. In such a case, the complex programmable logic device in the switch chassis transmits the first enable signal to a main power supply (a main DC-DC switching voltage regulator) in the switch chassis, whereby the main power supply may supply power to the switch and other components in the switch chassis.

Step 402, controlling the baseboard management controller in the switch chassis to transmit the power-on signal to a baseboard management controller in the device chassis and a baseboard management controller in the host chassis, to supply power to the target devices and the target computing units.

In some embodiments of the present disclosure, the baseboard management controller in the switch chassis transmits the power-on signal to the baseboard management controller in the device chassis and the baseboard management controller in the host chassis, to perform power-on operations on the target devices and the target computing units. The power-on signal transmitted to the complex programmable logic device in the device chassis is configured for enabling the complex programmable logic device in the device chassis to supply power to the target devices based on a second enable signal; and the power-on signal transmitted to a complex programmable logic device in the host chassis is configured for enabling the complex programmable logic device in the host chassis to supply power to the target computing units based on a third enable signal.

Specifically, after the baseboard management controller in the switch chassis transmits the power-on signal to the baseboard management controller in the device chassis, the baseboard management controller in the device chassis transmits the power-on signal to the complex programmable logic device in the device chassis via an inter-integrated circuit (I²C) bus or a universal asynchronous receiver/transmitter (UART) interface. The complex programmable logic device then transmits the second enable signal to the main power supply in the device chassis, whereby the main power supply may provide power to the target devices and other components in the device chassis. After the target devices and other components power on, the baseboard management controller in the device chassis may transmit a power-on completion signal back to the baseboard management controller in the switch chassis over a network, to notify the baseboard management controller in the switch chassis that the device chassis has powered on successfully. Correspondingly, the power-on process of the host chassis is the same as that of the device chassis. Specifically, after the baseboard management controller in the switch chassis transmits the power-on signal to the baseboard management controller in the host chassis, the baseboard management controller in the host chassis transmits the power-on signal to the complex programmable logic device in the host chassis via the I²C bus or the UART interface. The complex programmable logic device then transmits the third enable signal to the main power supply in the host chassis, whereby the main power supply may provide power to the target computing units (CPUs) and other components in the host chassis. After the target computing units and other components power on, the baseboard management controller in the host chassis transmits a power-on completion signal back to the baseboard management controller in the switch chassis over a network, to notify the baseboard management controller in the switch chassis that the host chassis has powered on successfully.

In some embodiments of the present disclosure, when the baseboard management controller in the switch chassis receives the power-on signal as well as power good signals from the device chassis and the host chassis, it indicates that the switch, the target devices, and the target computing units may be powered on synchronously. Accordingly, the switch is powered on based on the complex programmable logic device in the switch chassis, and the target devices and the target computing units are powered on based on the interaction between the baseboard management controller in the switch chassis, the baseboard management controller in the device chassis, and the baseboard management controller in the host chassis. In this way, the distributed resource management system may still support centralized power-on/off control on the basis of decoupled and pooled resources, thereby achieving power-on consistency.

Optionally, the power good signal includes a first power good signal. The first power good signal refers to a power good signal transmitted from the baseboard management controller in the device chassis to the baseboard management controller in the switch chassis.

Some embodiments of the present disclosure may include the following steps.

Step 501, controlling a power supply unit of a device chassis to supply power to components in the device chassis based on a standby voltage.

In some embodiments of the present disclosure, the power supply unit (PSU) of the device chassis is controlled to generate the standby voltage (the standby voltage may be obtained through conversion by an on-board DC-DC voltage regulator), and the standby voltage is transmitted to the components (including a baseboard management controller, a complex programmable logic device, etc.) in the device chassis. The standby voltage is configured for waking up the components in the device chassis, enabling the components to operate normally.

Step 502, in response to the components in the device chassis receiving the standby voltage, generating a power good signal and transmitting the power good signal to the complex programmable logic device and the baseboard management controller in the device chassis.

In some embodiments of the present disclosure, after the components in the device chassis receive the standby voltage, the power good (PG) signal is generated and transmitted to the complex programmable logic device in the device chassis. The complex programmable logic device then transmits the PG signal to the baseboard management controller in the device chassis via an I²C bus or a UART interface. Specifically, after a last standby voltage is transmitted to a corresponding component, the PG signal may be generated and then transmitted to the complex programmable logic device in the device chassis.

Step 503, controlling the baseboard management controller in the device chassis to transmit a first power good signal to the baseboard management controller in a switch chassis.

In some embodiments of the present disclosure, in response to the baseboard management controller in the device chassis receiving the power good signal, the baseboard management controller in the device chassis is controlled to transmit the first power good signal to the switch chassis. The first power good signal is configured to indicate that the device chassis has entered a standby mode and is ready for power-on.

In some embodiments of the present disclosure, a power supply unit of the device chassis first supplies power to the components in the device chassis, and then the power good signal is transmitted to the baseboard management controller in the switch chassis. Upon receiving the first power good signal, the baseboard management controller in the switch chassis may perform subsequent synchronous power-on based on the power-on signal and a second power good signal transmitted from the host chassis.

Optionally, the power good signal includes the second power good signal. The second power good signal is the power good signal transmitted from the baseboard management controller in the host chassis to the baseboard management controller in the switch chassis.

Some embodiments of the present disclosure may include the following steps.

Step 601, controlling a power supply unit of a host chassis to supply power to components in the host chassis based on a standby voltage.

In some embodiments of the present disclosure, the power supply unit (PSU) of the host chassis is controlled to generate the standby voltage (the standby voltage may be obtained through conversion by an on-board DC-DC voltage regulator), and the standby voltage is transmitted to the components in the host chassis (including a baseboard management controller, a complex programmable logic device, etc.). The standby voltage is configured for waking up the components in the host chassis, enabling the components to operate normally.

Step 602, in response to the components in the host chassis receiving the standby voltage, generating a power good signal and transmitting the power good signal to the complex programmable logic device and the baseboard management controller in the host chassis.

In some embodiments of the present disclosure, after the components in the host chassis receive the standby voltage, a power good (PG) signal is generated and transmitted to the complex programmable logic device in the host chassis. The complex programmable logic device then further transmits the PG signal to the baseboard management controller in the host chassis via an I²C bus or a UART interface. Specifically, after a last standby voltage is transmitted to a corresponding component, the PG signal may be generated and then transmitted to the complex programmable logic device in the host chassis.

Step 603, controlling the baseboard management controller in the host chassis to transmit a second power good signal to the baseboard management controller in the switch chassis.

In some embodiments of the present disclosure, in response to the baseboard management controller in the host chassis receiving the power good signal, the baseboard management controller in the host chassis is controlled to transmit a first power good signal to the switch chassis. The first power good signal is configured to indicate that the host chassis has entered a standby mode and is ready for power-on.

In some embodiments of the present disclosure, the power supply unit of the host chassis first supplies power to the components in the host chassis, and then the power good signal is transmitted to the baseboard management controller in the switch chassis. Upon receiving the second power good signal, the baseboard management controller in the switch chassis may perform subsequent synchronous power-on based on the power-on signal and the first power good signal transmitted from the device chassis.

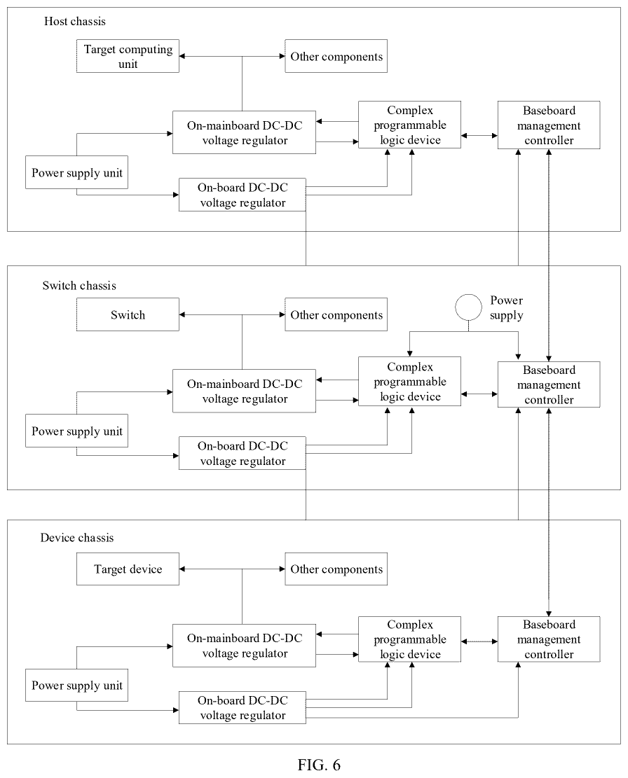

Exemplarily, FIG. 6 illustrates a topology diagram of coordinated power-on and power-off functionality of a distributed resource management system. According to FIG. 6, the synchronous power-on sequence for a switch, target devices, and target computing units are described: 1. After power supply units in a device chassis and a host chassis provide power, standby voltages are generated via on-board DC-DC voltage regulators and delivered to components in the device chassis and host chassis. 2. Upon receiving the standby voltages, the components in the device chassis and the host chassis respectively generate power good signals and the power good signals are transmitted to a baseboard management controller in a switch chassis via complex programmable logic devices and baseboard management controllers in the device chassis and the host chassis. 3. In response to receiving both power good signals from the baseboard management controller in the device chassis and the baseboard management controller in the host chassis and a power-on signal, the baseboard management controller in the switch chassis transmits the power-on signal to the complex programmable logic device in the switch chassis; and the complex programmable logic device in the switch chassis then transmits a first enable signal to a main power supply (a main DC-DC switching regulator) in the switch chassis, whereby the main power supply can deliver power to the switch and other components in the switch chassis. 4. Meanwhile, the power-on signal is also transmitted by the baseboard management controller in the switch chassis to the baseboard management controller in the device chassis and the baseboard management controller in the host chassis. 5. The baseboard management controller in the device chassis and the baseboard management controller in the host chassis then transmit the power-on signal to the complex programmable logic devices in their respective chassis, the complex programmable logic devices transmit enable signals to the main power supplies in their respective chassis, and then the main power supplies deliver power to the target devices and the target computing units.

Optionally, some embodiments of the present disclosure may include the following steps.

Step 701, controlling a baseboard management controller in a host chassis to scan a first interface corresponding to the host chassis and a switch chassis, to obtain a first topology diagram corresponding to the host chassis and the switch chassis.

In some embodiments of the present disclosure, the baseboard management controller in the host chassis scans the first interface corresponding to the host chassis and the switch chassis. The first interface may include interfaces indicating a connection relationship between the host chassis and the switch chassis, such as an interface which is on the host chassis and connected to the switch chassis and an interface which is on the switch chassis and connected to the host chassis. The baseboard management controller acquires local interface information corresponding to the host chassis and first interface information corresponding to the switch chassis. The local interface information corresponding to the host chassis may include identification information (ID) of the interface which is on the host chassis and connected to the switch chassis, and the first interface information includes identification information of the interface which is on the switch chassis and connected to the host chassis. Based on the local interface information corresponding to the host chassis and the first interface information corresponding to the switch chassis, the first topology diagram corresponding to the host chassis and the switch chassis is constructed. The first topology diagram may represent the connection relationship between the host chassis and the switch chassis, as well as interface-to-interface mappings.

Step 702, controlling a baseboard management controller in the switch chassis to scan a second interface corresponding to the device chassis and the switch chassis, to obtain a second topology diagram corresponding to the switch chassis and the device chassis.

In some embodiments of the present disclosure, the baseboard management controller in the switch chassis scans the second interface corresponding to the device chassis and the switch chassis. The second interface may include interfaces indicating a connection relationship between the device chassis and the switch chassis, such as an interface which is on the device chassis and connected to the switch chassis and an interface which is on the switch chassis and connected to the device chassis. The baseboard management controller acquires local interface information corresponding to the device chassis and second interface information corresponding to the switch chassis. The local interface information corresponding to the device chassis may include identification information (ID) of the interface which is on the device chassis and connected to the switch chassis, and the second interface information includes identification information of the interface which is on the switch chassis and connected to the device chassis. Based on the local interface information corresponding to the device chassis and the second interface information corresponding to the switch chassis, the second topology diagram corresponding to the device chassis and the switch chassis is constructed. The second topology diagram may represent the connection relationship between the device chassis and the switch chassis, as well as interface-to-interface mappings.

In some embodiments of the present disclosure, the first topology diagram and the second topology diagram enable convenient view of information on all resources within the distributed resource management system, such as resource node types, a power-on status, a global health status, a management IP address, and other functions, and support viewing interface topology interconnection information; and a connection state of each interface as well as information on the target devices or target computing units corresponding to the connected resources may be accessed via a Web interface or a Redfish page.

It can be understood that in order to improve operational efficiency of a system, the first topology diagram and the second topology diagram may be obtained in advance and stored in a designated location, and in this way, when operations need to be performed based on the first topology diagram and the second topology diagram, the first topology diagram and the second topology diagram may be directly obtained from the designated location.

In some embodiments of the present disclosure, the distributed resource management system can implement automatic discovery of resource topology and construction of the topology diagram, supports system topology view functionality, and improves the convenience and consistency of centralized resource management.

Optionally, a resource scheduling request includes a resource release request.

Correspondingly, Step 103 may include the following steps.

Step 801, in response to receiving the resource release request, removing a to-be-reconfigured device corresponding to a to-be-reallocated resource indicated by the resource release request from a second topology diagram and determining device information corresponding to the to-be-reconfigured device, wherein the target resources in the plurality of resource pools include the to-be-reallocated resource.

In some embodiments of the present disclosure, in response to the resource release request being received, the management engine may determine the to-be-reallocated resource indicated by the resource release request, and perform a hot removal on the to-be-reconfigured device corresponding to the to-be-reallocated resource from the second topology diagram, which indicates that the to-be-reconfigured device no longer participates in data exchange. Based on the second topology diagram, device information corresponding to the to-be-reconfigured device may be determined, wherein the to-be-reallocated resource may include a first resource and a second resource, and the to-be-reconfigured device may include the target computing units and the target devices. The device information may include a physical location of the device. Exemplarily, the to-be-reconfigured device and information on the to-be-reconfigured device may be removed from the second topology diagram.

It should be understood that prior to receiving the resource release request, it is necessary to ensure that application-layer processes associated with the to-be-reallocated resource have already been terminated. This prevents abnormal application-layer r accesses to the to-be-reconfigured device corresponding to the to-be-reallocated resource, which may lead to application exceptions.

Step 802, performing a reset operation on the to-be-reconfigured device based on the device information.

In some embodiments of the present disclosure, the reset operation is performed on the to-be-reconfigured device based on the device information. After the reset operation is completed, the to-be-reconfigured device may be rebooted, so that an operating state of the to-be-reconfigured device is restored to default values.

In some embodiments of the present disclosure, in response to the resource release request being received, the reset operation is performed on the to-be-reconfigured device corresponding to the to-be-reallocated resource, thereby releasing the to-be-reallocated resource and enabling dynamic scaling and resource release through the management engine.

Optionally, Step 802 may further include the following steps.

Step 8021, transmitting a reset signal to a complex programmable logic device in a switch chassis based on a baseboard management controller in the switch chassis.

Step 8022, transmitting the reset signal to a complex programmable logic device in the device chassis corresponding to the to-be-reconfigured device by the complex programmable logic device in the switch chassis via a target interface, wherein the complex programmable logic device is configured to forward the reset signal to the to-be-reconfigured device to perform a reset operation.

In some embodiments of the present disclosure, the performing a reset operation on the to-be-reconfigured device may include: generating a first reset signal based on the baseboard management controller in the switch chassis, transmitting the first reset signal to the complex programmable logic device in the switch chassis, and transmitting the first reset signal to the complex programmable logic device in the device chassis corresponding to the to-be-reconfigured device by the complex programmable logic device in the switch chassis via the target interface. In response to receiving the first reset signal, the complex programmable logic device in the device chassis forwards the first reset signal to the to-be-reconfigured device, to perform the reset operation on the to-be-reconfigured device.

In some embodiments of the present disclosure, signal transmission between the baseboard management controller and the complex programmable logic device in the switch chassis, and the device chassis corresponding to the to-be-reconfigured device enables the reset functionality of the to-be-reconfigured device. In this way, the to-be-reallocated resource may be released to enhance the flexibility of resource allocation.

Optionally, a resource scheduling request further includes a resource acquisition request. The embodiments of the present disclosure further include the following steps.

Step 901, allocating a to-be-reallocated resource to a designated computing unit indicated by the resource acquisition request based on the resource acquisition request.

In some embodiments of the present disclosure, after being released, the to-be-reallocated resource may be allocated to the designated computing unit indicated by the resource acquisition request based on the resource acquisition request for use by the designated computing unit.

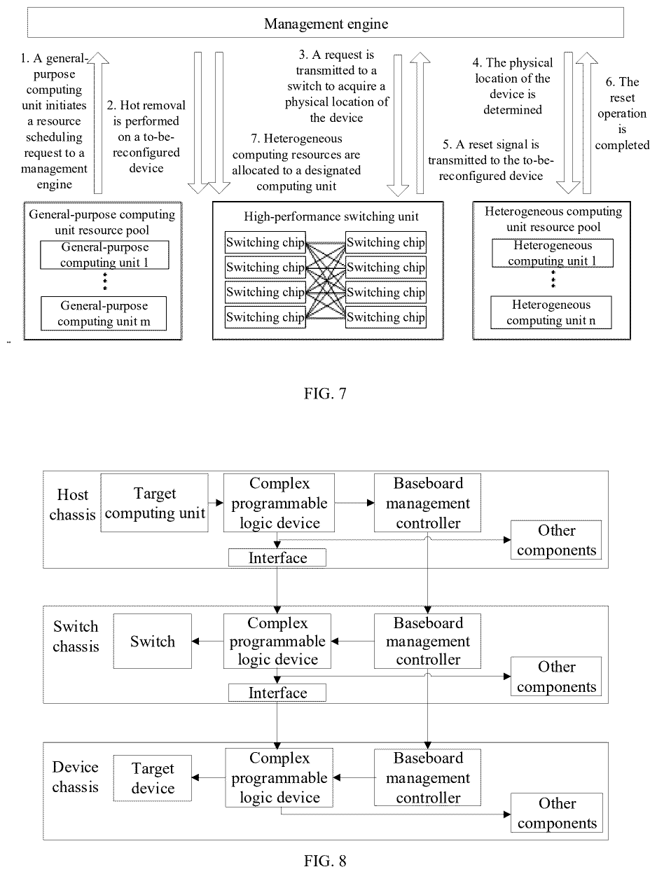

Exemplarily, FIG. 7 illustrates a flowchart of steps of scheduling resources. As shown in FIG. 7, a general-purpose computing unit resource pool (i.e., a target computing unit resource pool), which includes a resource pool constructed by general-purpose computing units 1 through m, and a heterogeneous computing unit resource pool (i.e., an accelerator resource pool), which includes a resource pool constructed by heterogeneous computing units (e.g., GPUs, FPGAs) 1 through n are included. A high-performance switching unit, i.e., the switch, may include a plurality of switch chips. In practical application scenarios, when an application stops running, resources corresponding to the application may be released back to respective resource pools, thereby enabling efficient resource circulation and maximizing utilization. An example in which a heterogeneous accelerator card device (a target device) is released and allocated to the general-purpose computing unit (a target computing unit) is taken. First, it may be ensured that application-layer processes associated with the heterogeneous accelerator card device have already been terminated. A user then triggers a resource scheduling request, which includes a resource release request and a resource acquisition request. Specifically, in response to receiving a resource scheduling instruction from the user, the target computing unit (i.e., the general-purpose computing unit) initiates the resource scheduling request to a management engine. A hot removal is performed on the to-be-reconfigured device (i.e., the heterogeneous computing unit) corresponding to the to-be-reallocated resource (i.e., the heterogeneous accelerator card resource) indicated by the resource release request based on the management engine, and a request is transmitted to the switch to acquire a physical location of the to-be-reconfigured device (i.e., the heterogeneous computing unit) corresponding to the to-be-reallocated resource. Based on the physical location of the device, the heterogeneous computing device resource is reset and the to-be-reconfigured device is rebooted, so that an operating state of the to-be-reconfigured device is restored to default values. After the reset operation is completed, the management engine reallocates the heterogeneous computing device resource to the designated computing unit (i.e., the general-purpose computing unit indicated by the resource acquisition request). In this way, the designated computing unit may perceive the presence of a newly added device (i.e., the heterogeneous accelerator card device) without service interruption, thereby completing a dynamic switching of heterogeneous computing resources.

In some embodiments of the present disclosure, on-demand resource allocation may be achieved based on the resource acquisition request, enabling dynamic resource scheduling and improving the flexibility of resource allocation.

Optionally, the reset instruction includes a system reset instruction, and a to-be-reset device includes the switch, the target computing units, and the target devices.

In some embodiments of the present disclosure, the reset instruction may include a system reset instruction, and the system reset instruction is configured for indicating a system-wide reset operation. Correspondingly, the to-be-reset device may include the switch, the target computing units, and the target devices.

Correspondingly, Step 102 may include the following steps.

Step 1001, generating a system reset signal by the target computing unit based on the system reset instruction, and performing a reset operation on the target computing unit by the target computing unit based on the system reset signal.

Step 1002, controlling the target computing unit to transmit the system reset signal to a complex programmable logic device in a switch chassis and a complex programmable logic device in a device chassis, to perform reset operations on the switch and the target devices.

In some embodiments of the present disclosure, based on the system reset instruction, the target computing unit generates the system reset signal and transmits the system reset signal to other components in a host chassis (e.g., a baseboard management controller, a complex programmable logic device, a network interface card, etc.) corresponding to the target computing unit, to perform reset operations on both the target computing unit and associated devices. The target computing unit transmits the system reset signal to a complex programmable logic device in the switch chassis and a complex programmable logic device in the device chassis, whereby the complex programmable logic device in the switch chassis and the complex programmable logic device in the device chassis perform reset operations on the switch and the target device based on the system reset signal. Exemplarily, as shown in FIG. 8, a target computing unit may transmit a system reset signal to a complex programmable logic device in a host chassis, and then the complex programmable logic device transmits the system reset signal to a baseboard management controller and other devices in the host chassis. The baseboard management controller in the host chassis transmits the system reset signal to the baseboard management controller in the switch chassis via an Ethernet switch. The switch is reset based on the system reset signal transmitted from the baseboard management controller in the switch chassis via the complex programmable logic device in the switch chassis. The baseboard management controller in the switch chassis transmits the system reset signal to the complex programmable logic device in the device chassis via a target interface in the switch chassis, and the target device is reset based on the system reset signal transmitted from the complex programmable logic device in the device chassis.

Optionally, Step 1002 includes the following steps.

Step 1101, controlling the target computing unit to transmit the system reset signal to the baseboard management controller in the switch chassis via the baseboard management controller in the host chassis.

In some embodiments of the present disclosure, in response to receiving the system reset signal transmitted by the target computing unit, the baseboard management controller in the host chassis transmits the system reset signal to the baseboard management controller in the switch chassis via Ethernet.

Step 1102, controlling the baseboard management controller in the switch chassis to transmit the system reset signal to the complex programmable logic device in the switch chassis and to the switch, to perform a reset operation on the switch.

In some embodiments of the present disclosure, the baseboard management controller in the switch chassis transmits the system reset signal to the complex programmable logic device in the switch chassis, and then the complex programmable logic device in the switch chassis transmits the system reset signal to the switch to perform a reset operation on the switch.

Step 1103, controlling the baseboard management controller in the switch chassis to transmit the system reset signal to the complex programmable logic device in the device chassis via a target interface, wherein the system reset signal is configured for enabling the complex programmable logic device in the device chassis to perform a reset operation based on the system reset signal.

In some embodiments of the present disclosure, the baseboard management controller in the switch chassis transmits the system reset signal to the complex programmable logic device in the switch chassis, and the complex programmable logic device in the switch chassis transmits the system reset signal to the complex programmable logic device in the device chassis via the target interface. The complex programmable logic device in the device chassis transmits the system reset signal to the target device, to perform the reset operation on the target device.

In some embodiments of the present disclosure, the system reset signal is generated by the target computing unit and signal transmission between the host chassis, the switch chassis, and the device chassis enables a system-wide reset operation based on automatically detected system reset signals.

Optionally, the reset instruction includes a device reset instruction, and the to-be-reset device includes a target reset device. Some embodiments of the present disclosure further include the following steps.

Step 1201, generating a device reset signal by a baseboard management controller in the switch chassis based on the device reset instruction, and transmitting the device reset signal to a complex programmable logic device in the switch chassis.

Step 1202, controlling the complex programmable logic device in the switch chassis to transmit the device reset signal to a complex programmable logic device in a target device chassis corresponding to the device reset instruction via a target interface, to perform a reset operation on the target reset device indicated by the device reset instruction.

In some embodiments of the present disclosure, in response to the device reset instruction being received, the baseboard management controller in the switch chassis generates the device reset signal, and transmits the device reset signal to the complex programmable logic device in the switch chassis. The complex programmable logic device in the switch chassis transmits the device reset signal to the complex programmable logic device in the target device chassis corresponding to the device reset instruction via the target interface, and the complex programmable logic device in the target device chassis transmits the device reset signal to the target reset device in the target device chassis to perform a reset operation on the target reset device. The target device chassis refers to a device chassis where the target reset device indicated by the device reset instruction is located.

In some embodiments of the present disclosure, the device reset signal is generated by the baseboard management controller in the switch chassis and signal transmission between the switch chassis and the device chassis enables a reset operation for the corresponding target reset device based on automatically detected device reset signals.

Optionally, some embodiments of the present disclosure may include the following steps.

Step 1301, acquiring device asset information and interface connection state information corresponding to the target device in the distributed resource management system by a master management controller.

In some embodiments of the present disclosure, a node management controller may collect asset information of a resource pool (including device asset information of the target device and computing asset information of the target computing unit) as well as interface connection state information. The node management controller then transmits the asset information of the resource pool and interface connection state information to the master management controller, whereby the master management controller performs asset monitoring and interface connection state monitoring on the distributed resource management system.

FIG. 9 is a schematic structural diagram of an apparatus of distributed resource management provided by some embodiments of the present disclosure. The apparatus of distributed resource management is applied to a distributed resource management system deployed in a server. The distributed resource management system includes a switch and a plurality of resource pools. The plurality of resource pools are formed by respectively connecting the switch to first resources corresponding to a target device in the server or second resources corresponding to a target computing unit in the server via compute express link (CXL).

As shown in FIG. 9, the apparatus specifically includes:
a first control module 1401, configured to control the switch, the target device, and the target computing unit to power on synchronously in response to receiving a power-on instruction;
a first reset module 1402, configured to perform a reset operation on a to-be-reset device indicated by a reset instruction in response to receiving the reset instruction, wherein the to-be-reset device includes at least one of the target device, the target computing unit, and the switch; and
a first scheduling module 1403, configured to perform resource scheduling on target resources in the plurality of resource pools based on a resource scheduling request, wherein the resource scheduling includes resource reset and resource allocation.

Optionally, the apparatus further includes:
a first determination module, configured to determine a fault location, a fault type, and a fault recovery strategy based on the target fault information in response to collecting target fault information corresponding to any one of the resource pools.

Optionally, the apparatus further includes:
a first acquisition module, configured to acquire resource usage information corresponding to the target device and the target computing unit; and
a first analysis module, configured to perform resource analysis on the target device and the target computing unit based on the resource usage information to obtain resource monitoring data.

Optionally, the switch may be deployed in a switch chassis, the target device may be deployed in a device chassis, and the target computing unit may be deployed in a host chassis. The first control module 1401 includes:
a first control submodule, configured to control a complex programmable logic device in the switch chassis to supply power to the switch based on a first enable signal in response to a baseboard management controller in the switch chassis receiving a power-on signal and a power good signal from the device chassis and the host chassis, wherein the power-on signal is generated based on the power-on instruction; and
a second control submodule, configured to control the baseboard management controller in the switch chassis to transmit the power-on signal to a baseboard management controller in the device chassis and a baseboard management controller in the host chassis, to supply power to the target device and the target computing unit.

Optionally, the power good signal includes a first power good signal. The apparatus further includes:
a second control module, configured to control a power supply unit of the device chassis to supply power to components in the device chassis based on a standby voltage;
a first transmission module, configure to generate a power good signal and transmit the power good signal to a complex programmable logic device and the baseboard management controller in the device chassis in response to the components in the device chassis receiving the standby voltage; and
a third control module, configured to control the baseboard management controller in the device chassis to transmit the first power good signal to the baseboard management controller in the switch chassis.

Optionally, the power good signal includes the second power good signal. The apparatus further includes:
a fourth control module, configured to control a power supply unit of the host chassis to supply power to components in the host chassis based on a standby voltage;
a second transmission module, configured to generate a power good signal and transmit the power good signal to the complex programmable logic device and the baseboard management controller in the host chassis in response to the components in the host chassis receiving the standby voltage; and
a fifth control module, configured to control the baseboard management controller in the host chassis to transmit the second power good signal to the baseboard management controller in the switch chassis.

Optionally, the apparatus further includes:
a second acquisition module, configured to control the baseboard management controller in the host chassis to scan a first interface corresponding to both the host chassis and the switch chassis, to obtain a first topology diagram corresponding to the host chassis and the switch chassis; and
a third acquisition module, configured to control the baseboard management controller in the switch chassis to scan a second interface corresponding to both the device chassis and the switch chassis, to obtain a second topology diagram corresponding to the switch chassis and the device chassis.

Optionally, a resource scheduling request includes a resource release request. The first scheduling module 1403 includes:
a second determination module, configured to remove a to-be-reconfigured device corresponding to a to-be-reallocated resource indicated by the resource release request from the second topology diagram and determine device information corresponding to the to-be-reconfigured device in response to receiving the resource release request, wherein the target resources in the plurality of resource pools include the to-be-reallocated resource; and
a second reset module, configured to reset the to-be-reconfigured device based on the device information.

Optionally, the second reset module includes:
a third transmission module, configured to transmit a first reset signal to the complex programmable logic device in the switch chassis based on the baseboard management controller in the switch chassis; and
a fourth transmission module, configured to transmit the first reset signal to a complex programmable logic device in the device chassis corresponding to the to-be-reconfigured device by the complex programmable logic device in the switch chassis via a target interface, wherein the complex programmable logic device in the device chassis is configured to forward the first reset signal to the to-be-reconfigured device to perform a reset operation.

Optionally, the resource scheduling request further includes a resource acquisition request. The apparatus further includes:
a first allocation module, configured to allocate the to-be-reallocated resource to a designated computing unit indicated by the resource acquisition request based on the resource acquisition request.

Optionally, the reset instruction includes a system reset instruction, and the to-be-reset device includes the switch, the target computing unit, and the target device. The first reset module 1402 includes:
a first generation module, configured to generate a system reset signal by the target computing unit based on the system reset instruction, and perform a reset operation on the target computing unit by the target computing unit based on the system reset signal; and
a sixth control module, configured to control the target computing unit to transmit the system reset signal to a complex programmable logic device in a switch chassis and a complex programmable logic device in a device chassis, to perform reset operations on the switch and the target device.

Optionally, the sixth control module includes:
a first control submodule, configured to control the target computing unit to transmit the system reset signal to a baseboard management controller in the switch chassis via a baseboard management controller in the host chassis;
a second control submodule, configured to control the baseboard management controller in the switch chassis to transmit the system reset signal to the complex programmable logic device in the switch chassis and to the switch, to perform a reset operation on the switch; and
a third control submodule, configured to control the baseboard management controller in the switch chassis to transmit the system reset signal to the complex programmable logic device in the device chassis via a target interface, wherein the system reset signal is configured for enabling the complex programmable logic device in the device chassis to perform a reset operation based on the system reset signal.

Optionally, the reset instruction includes a device reset instruction, and the to-be-reset device includes a target reset device. The first reset module 1402 includes:
a fifth transmission module, configured to generate a device reset signal by the baseboard management controller in a switch chassis based on the device reset instruction, and transmit the device reset signal to the complex programmable logic device in the switch chassis; and
a seventh control module, configured to control the complex programmable logic device in the switch chassis to transmit the device reset signal to a complex programmable logic device in a target device chassis corresponding to the device reset instruction via a target interface, to perform a reset operation on the target reset device indicated by the device reset instruction.

Optionally, the distributed resource management system further includes a master management controller; and the apparatus further includes:
a fourth acquisition module, configured to acquire device asset information and interface connection state information corresponding to the target device in the distributed resource management system by the master management controller.

The present disclosure further provides a distributed resource management system, which is configured to implement the method of distributed resource management according to some embodiments of the present disclosure.

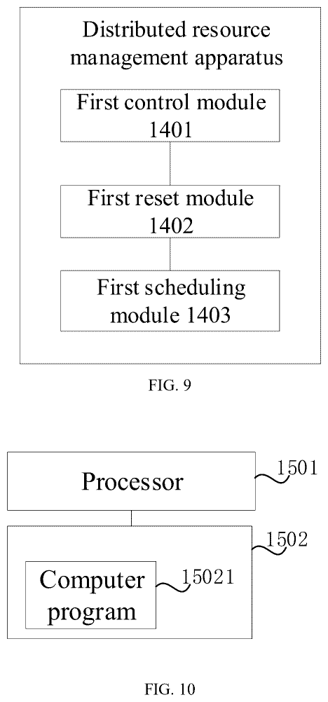

The present disclosure further provides an electronic device. As shown in FIG. 10, the electronic device includes a processor 1501, a memory 1502, and a computer program 15021 stored on the memory and runnable on the processor, wherein the processor, when executing the program, performs the method of distributed resource management according to some embodiments of the present disclosure.

The present disclosure further provides a non-transitory readable storage medium, wherein when instructions stored in the non-transitory readable storage medium are executed by a processor of an electronic device, the electronic device is caused to implement the method of distributed resource management according to some embodiments of the present disclosure.

For certain embodiments of the apparatus, since they are substantially similar to some embodiments of the method, the description is relatively brief, and reference may be made to the corresponding portions of the description of some embodiments of the method for relevant details.

The algorithms and displays presented herein are not inherently related to any particular computer, virtual system, or other apparatus. Various general-purpose systems may also be used with programs in accordance with the teachings herein. The required structure for such systems will be apparent from the description above. In addition, the present disclosure is not directed to any particular programming language. It will be appreciated that a variety of programming languages may be used to implement the teachings of the present disclosure as described herein, and any descriptions of specific languages are provided to disclose the best embodiment of the present disclosure.

In the description provided herein, numerous specific details are set forth. However, it is to be understood that embodiments of the present disclosure may be practiced without these specific details. In some examples, well-known methods, structures, and techniques have not been shown in detail in order not to obscure the understanding of this description.

Similarly, it should be understood that in order to simplify the present disclosure and aid in understanding one or more of the inventive aspects, various features of the present disclosure are sometimes grouped together into a single embodiment, figure, or description thereof in the above description of some embodiments of the present disclosure. However, the disclosed method should not be interpreted as reflecting an intention that the claimed disclosure requires more features than those expressly recited in each claim. Rather, as the following claims reflect, inventive aspects lie in less than all features of a single disclosed embodiment. Thus, the claims following the detailed description are hereby expressly incorporated into this detailed description, with each claim standing on its own as a separate embodiment of the present disclosure.

Those skilled in the art will appreciate that modules in the apparatus of some embodiments may be adaptively modified and arranged in one or more devices different from those of some embodiments. The modules, units, or components of some embodiments may be combined into a single module, unit, or component, and may further be divided into multiple sub-modules, sub-units, or sub-components. Except where such features and/or processes or units are mutually exclusive, any combination may be employed to combine all features disclosed in this specification (including accompanying claims, abstract, and drawings) and all processes or units of any method or apparatus so disclosed. Unless expressly stated otherwise, each feature disclosed in this specification (including accompanying claims, abstract, and drawings) may be replaced by alternative features serving the same, equivalent, or similar purpose.

Some embodiments of various components of the present disclosure may be implemented in hardware, or in software modules running on one or more processors, or in a combination thereof. Those skilled in the art will appreciate that a microprocessor or digital signal processor (DSP) may be used in practice to implement some or all of the functions of some or all of the components in the sequencing device according to the present disclosure. The present disclosure may also be implemented as apparatus or device programs for performing part or all of the methods described herein. Such programs implementing the present disclosure may be stored on non-transitory computer readable medium or may take the form of one or more signals. Such signals may be downloaded from Internet websites, provided on carrier signals, or provided in any other form.

It should be noted that the embodiments illustrate rather than limit the present disclosure, and those skilled in the art will be able to design alternative embodiments without departing from the scope of the appended claims. In the claims, any reference signs placed between parentheses shall not be construed as limiting the claims. The word “including” does not exclude the presence of elements or steps not listed in the claims. The word “a” or “an” preceding an element does not exclude the presence of a plurality of such elements. The present disclosure may be implemented by means of hardware including several distinct elements and by means of a suitably programmed computer. In a unit claim enumerating several means, several of these means may be embodied by one and the same item of hardware. The use of the words first, second, third, etc., does not indicate any ordering. These words may be interpreted as names.

Those skilled in the art will clearly understand that, for the convenience and brevity of description, the specific working processes of the systems, apparatuses, and units described above may refer to the corresponding processes in the embodiments of the aforementioned methods, and are not repeated here.

It should be pointed out that all actions of obtaining signals, information, or data in the present disclosure are performed under the premise of complying with the data protection laws and policies of the relevant country and with the authorization given by the owner of the corresponding device.

The above are only some preferred embodiments of the present disclosure and are not intended to limit the present disclosure. Any modifications, equivalent replacements, and improvements made within the spirit and principles of the present disclosure shall be included within the protection scope of the present disclosure.

The above are only specific implementations of the present disclosure, but the protection scope of the present disclosure is not limited thereto. Any person skilled in the art may easily think of changes or substitutions within the technical scope disclosed in the present disclosure, which shall be covered within the protection scope of the present disclosure. Therefore, the protection scope of the present disclosure shall be subject to the protection scope of the claims.

1. A method of distributed resource management, applied to a distributed resource management system deployed in a server, wherein the distributed resource management system comprises a switch and a plurality of resource pools, the plurality of resource pools are formed by respectively connecting the switch to first resources corresponding to a target device in the server or to second resources corresponding to a target computing unit in the server via compute express link, the target computing unit includes a processor, the target device includes a memory, a hard disk and an accelerator; and the method comprises:
in response to receiving a power-on instruction, controlling the switch, the target device, and the target computing unit to power on synchronously;
in response to receiving a reset instruction, performing a reset operation on a to-be-reset device indicated by the reset instruction, wherein the to-be-reset device comprises at least one of the target device, the target computing unit, and the switch; and
performing resource scheduling on target resources in the plurality of resource pools based on a resource scheduling request, wherein the resource scheduling comprises resource reset and resource allocation; and
wherein the switch is deployed in a switch chassis, the target device is deployed in a device chassis, and the target computing unit is deployed in a host chassis; and the method further comprises:
controlling a baseboard management controller in the host chassis to scan a first interface corresponding to both the host chassis and the switch chassis, to obtain a first topology diagram corresponding to the host chassis and the switch chassis; and
controlling a baseboard management controller in the switch chassis to scan a second interface corresponding to both the device chassis and the switch chassis, to obtain a second topology diagram corresponding to the switch chassis and the device chassis.

2. The method according to claim 1, further comprising:
in response to collecting target fault information corresponding to any one of the resource pools, determining a fault location, a fault type, and a fault recovery strategy based on the target fault information.

3. The method according to claim 1, wherein the switch comprises a core switch and a plurality of access switches, the core switch is connected to the plurality of access switches, and each access switch is configured to connect to a plurality of target devices of the same type or to a plurality of target computing units of the same type via the compute express link.

4. The method according to claim 1, further comprising:
acquiring resource usage information corresponding to the target device and the target computing unit; and
performing resource analysis on the target device and the target computing unit based on the resource usage information, to obtain resource monitoring data.

5. The method according to claim 1, wherein the in response to receiving a power-on instruction, controlling the switch, the target device, and the target computing unit to power on synchronously comprises:
in response to the baseboard management controller in the switch chassis receiving a power-on signal and a power good signal from the device chassis and the host chassis, controlling a complex programmable logic device in the switch chassis to supply power to the switch based on a first enable signal, wherein the power-on signal is generated based on the power-on instruction; and
controlling the baseboard management controller in the switch chassis to transmit the power-on signal to a baseboard management controller in the device chassis and the baseboard management controller in the host chassis, to supply power to the target device and the target computing unit.

6. The method according to claim 5, wherein a power-on signal transmitted to a complex programmable logic device in the device chassis is configured for enabling the complex programmable logic device in the device chassis to supply power to the target device based on a second enable signal; and
a power-on signal transmitted to a complex programmable logic device in the host chassis is configured for enabling the complex programmable logic device in the host chassis to supply power to the target computing unit based on a third enable signal.

7. The method according to claim 5, wherein the power good signal comprises a first power good signal, and the method further comprises:
controlling a power supply unit of the device chassis to supply power to components in the device chassis based on a standby voltage;
in response to the components in the device chassis receiving the standby voltage, generating a power good signal and transmitting the power good signal to a complex programmable logic device and the baseboard management controller in the device chassis; and
controlling the baseboard management controller in the device chassis to transmit the first power good signal to the baseboard management controller in the switch chassis.

8. The method according to claim 5, wherein the power good signal comprises a second power good signal, and the method further comprises:
controlling a power supply unit of the host chassis to supply power to components in the host chassis based on a standby voltage;
in response to the components in the host chassis receiving the standby voltage, generating a power good signal and transmitting the power good signal to the complex programmable logic device and the baseboard management controller in the host chassis; and
controlling the baseboard management controller in the host chassis to transmit the second power good signal to the baseboard management controller in the switch chassis.

9. (canceled)

10. The method according to claim 9, wherein the resource scheduling request comprises a resource release request, and the performing resource scheduling on target resources in the plurality of resource pools based on a resource scheduling request comprises:
in response to receiving the resource release request, removing a to-be-reconfigured device corresponding to a to-be-reallocated resource indicated by the resource release request from the second topology diagram and determining device information corresponding to the to-be-reconfigured device, wherein the target resources in the plurality of resource pools comprise the to-be-reallocated resource; and
resetting the to-be-reconfigured device based on the device information.

11. The method according to claim 10, wherein the resetting the to-be-reconfigured device comprises:
transmitting a first reset signal to the complex programmable logic device in the switch chassis based on the baseboard management controller in the switch chassis; and
transmitting the first reset signal to a complex programmable logic device in the device chassis corresponding to the to-be-reconfigured device by the complex programmable logic device in the switch chassis via a target interface, wherein the complex programmable logic device in the device chassis is configured to forward the first reset signal to the to-be-reconfigured device to perform a reset operation.

12. The method according to claim 10, wherein the resource scheduling request further comprises a resource acquisition request, and the method further comprises:
allocating the to-be-reallocated resource to a designated computing unit indicated by the resource acquisition request based on the resource acquisition request.

13. The method according to claim 1, wherein the reset instruction comprises a system reset instruction, and the to-be-reset device comprises the switch, the target computing unit, and the target device; and the in response to receiving a reset instruction, performing a reset operation on a to-be-reset device indicated by the reset instruction comprises:
generating a system reset signal by the target computing unit based on the system reset instruction, and performing a reset operation on the target computing unit by the target computing unit based on the system reset signal; and
controlling the target computing unit to transmit the system reset signal to a complex programmable logic device in a switch chassis and a complex programmable logic device in a device chassis, to perform reset operations on the switch and the target device.

14. The method according to claim 13, wherein the controlling the target computing unit to transmit the system reset signal to a complex programmable logic device in a switch chassis and a complex programmable logic device in a device chassis comprises:
controlling the target computing unit to transmit the system reset signal to a baseboard management controller in the switch chassis via a baseboard management controller in a host chassis;
controlling the baseboard management controller in the switch chassis to transmit the system reset signal to the complex programmable logic device in the switch chassis and to the switch, to perform a reset operation on the switch; and
controlling the baseboard management controller in the switch chassis to transmit the system reset signal to the complex programmable logic device in the device chassis via a target interface, wherein the system reset signal is configured for enabling the complex programmable logic device in the device chassis to perform a reset operation based on the system reset signal.

15. The method according to claim 1, wherein the reset instruction comprises a device reset instruction, and the to-be-reset device comprises a target reset device; and the in response to receiving a reset instruction, performing a reset operation on a to-be-reset device indicated by the reset instruction comprises:
generating a device reset signal by a baseboard management controller in a switch chassis based on the device reset instruction, and transmitting the device reset signal to a complex programmable logic device in the switch chassis; and
controlling the complex programmable logic device in the switch chassis to transmit the device reset signal to a complex programmable logic device in a target device chassis corresponding to the device reset instruction via a target interface, to perform a reset operation on the target reset device indicated by the device reset instruction.

16. The method according to claim 1, wherein the distributed resource management system further comprises a master management controller; and the method further comprises:
acquiring device asset information and interface connection state information corresponding to the target device in the distributed resource management system by the master management controller.

17. An apparatus of distributed resource management, applied to a distributed resource management system deployed in a server, wherein the distributed resource management system comprises a switch and a plurality of resource pools, the plurality of resource pools are formed by respectively connecting the switch to first resources corresponding to a target device in the server or to second resources corresponding to a target computing unit in the server via compute express link, the target computing unit includes a first processor, the target device includes a first memory, a hard disk and an accelerator; and the apparatus comprises a second processor, a second memory, wherein instructions stored in the second memory and runnable on the second processor, and wherein, when executing the instructions, the second processor is configured to:
control the switch, the target device, and the target computing unit to power on synchronously in response to receiving a power-on instruction;
perform a reset operation on a to-be-reset device indicated by a reset instruction in response to receiving the reset instruction, wherein the to-be-reset device comprises at least one of the target device, the target computing unit, and the switch; and
perform resource scheduling on target resources in the plurality of resource pools based on a resource scheduling request, wherein the resource scheduling comprises resource reset and resource allocation; and
wherein the switch is deployed in a switch chassis, the target device is deployed in a device chassis, and the target computing unit is deployed in a host chassis; and the apparatus further configured to:
control a baseboard management controller in the host chassis to scan a first interface corresponding to both the host chassis and the switch chassis, to obtain a first topology diagram corresponding to the host chassis and the switch chassis; and
control a baseboard management controller in the switch chassis to scan a second interface corresponding to both the device chassis and the switch chassis, to obtain a second topology diagram corresponding to the switch chassis and the device chassis.

18. A distributed resource management system, wherein the distributed resource management system comprises the apparatus of distributed resource management according to claim 17.

19. (canceled)

20. A non-transitory readable storage medium, wherein when instructions stored in the non-transitory readable storage medium are executed by a processor of an electronic device, the electronic device is caused to implement the method of distributed resource management according to claim 1.

21. The apparatus according to claim 17, wherein the apparatus is further configured to:
determine a fault location, a fault type, and a fault recovery strategy based on the target fault information in response to collecting target fault information corresponding to any one of the resource pools.

22. The apparatus according to claim 17, wherein the apparatus is further configured to:
acquire resource usage information corresponding to the target device and the target computing unit; and
perform resource analysis on the target device and the target computing unit based on the resource usage information, to obtain resource monitoring data.
